(19) United States
(12) Patent Application Publication
(10) Pub. No.: US 2009/0071179 A1
(43) Pub. Date: Mar. 19, 2009

(54) Compressor manifold for an air conditioning system of a machine

(75) Inventors: Thomas M. Lamkin, JR., Clinton, IL (US); David Berry, Bloomington, IL (US); James W. Reinhart, Decatur, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/901,587

(22) Filed: Sep. 18, 2007

(51) Int. Cl. B60H 1/32; B21D 53/02

(52) U.S. Cl. 62/243; 29/890.03

(57) ABSTRACT

A machine having an air conditioning system includes a compressor having an inlet and an outlet. A manifold having a housing is attached to the compressor and includes a low pressure channel for directing a low pressure refrigerant from a low pressure port of the manifold to the compressor inlet. The manifold also includes a high pressure channel for directing a compressed refrigerant from the compressor outlet to a high pressure port of the manifold. At least one additional port is in fluid communication with one of the high pressure channel and the low pressure channel.

### TECHNICAL FIELD

The present disclosure relates generally to a compressor manifold for an air conditioning system of a machine, and more particularly to a compressor manifold having a low pressure channel, a high pressure channel, and at least one additional port.

### BACKGROUND

Air conditioning systems are increasingly being used to cool operator control stations of machines. In fact, for some machines that typically operate in extreme temperatures, air conditioning systems have become standard features. Machine air conditioning systems are similar to vehicle air conditioning systems and generally include devices, such as compressors, condensers, and evaporators, for transferring a refrigerant through the system. The refrigerant changes from liquid to gas and from gas to liquid as it is transferred throughout the system, thereby absorbing and transferring heat.

The compressor is a major component of the air conditioning system and is responsible for compressing and transferring refrigerant gas. The compressor is basically a pump having an intake side for drawing in a low pressure refrigerant gas and a discharge side for releasing the high pressure, or compressed, refrigerant gas. The intake side typically receives the refrigerant gas through a hose or conduit coupled to the intake via an appropriate fitting. Similarly, the compressed refrigerant gas is transported from the discharge side and through a hose coupled to the discharge via an additional fitting.

In some applications, one or both of the compressor fittings may have a substantial length, and may include one or more bends, due to spatial constraints and/or access limitations. Specifically, each fitting may include one or more additional ports or valves for attaching sensors and/or service lines and, therefore may require a specific configuration to accommodate access to each of the additional ports and valves. However, since many machines operate in environments subject to extreme vibrations, the length of these fittings may contribute to premature failures at bends and/or connections, such as, for example, welds. In addition, the fitting attached to the discharge side of the compressor experiences cyclic loads when the compressor surges and may, therefore, be subject to even greater cyclic stresses at these joints.

Since these fittings are subject to extreme repetitive forces, it may be desirable to replace the separate fittings with a compressor manifold having a unitary housing. One such manifold is disclosed in U.S. Pat. No. 6,568,920. Specifically, the housing includes a suction chamber for guiding a refrigerant from an intake port to a compression chamber of the compressor and a discharge chamber for guiding the refrigerant from the compression chamber to an exhaust port. The compressor manifold further includes a baffle for obstructing the flow of refrigerant traveling through the discharge chamber, thereby supposedly eliminating acoustic resonance of the refrigerant in the discharge chamber. Although this manifold provides a unitary structure for positioning the compressor inlet and outlet in close proximity to the respective hoses to which they connect, thereby reducing the moment arm of the lengthy fittings, it does not provide a versatile structure for connecting additional ports to the inlet and outlet of the compressor.

The present disclosure is directed to one or more of the problems set forth above.

### SUMMARY OF THE DISCLOSURE

In one aspect, a machine having an air conditioning system includes a compressor having an inlet and an outlet. A manifold, having a housing, is attached to the compressor and includes a low pressure channel for directing a low pressure refrigerant from a low pressure port of the manifold to the compressor inlet. The manifold also includes a high pressure channel for directing a compressed refrigerant from the compressor outlet to a high pressure port of the manifold. At least one additional port is in fluid communication with one of the high pressure channel and the low pressure channel.

In another aspect, a compressor manifold for an air conditioning system of a machine includes a housing having a first face, a second face, a third face, a fourth face, a fifth face, and a sixth face defining a low pressure channel and a high pressure channel. The first face includes a first annular flange for engaging the compressor inlet and a second annular flange parallel to and spaced apart from the first annular flange for engaging the compressor outlet. A low pressure port opens through one of the second through sixth faces and is in fluid communication with the low pressure channel. A high pressure port opens through one of the second through sixth faces and is in fluid communication with the high pressure channel. A fastener bore extends through the housing between the low pressure channel and the high pressure channel and receives a fastener therethrough. At least one additional port opens through one of the second through sixth faces and is in fluid communication with one of the high pressure channel and the low pressure channel.

In yet another aspect, a method of assembling an air conditioning system of a machine includes a step of positioning a manifold over a compressor inlet and a compressor outlet. A low pressure channel of the manifold is in fluid communication with the compressor inlet and a high pressure channel of the manifold is in fluid communication with the compressor outlet. The manifold is secured to the compressor with a threaded fastener extending through a fastener bore within the manifold and into a threaded receiving bore within the compressor. The method also includes steps of coupling a high pressure conduit to a high pressure port of the manifold and coupling a low pressure conduit to a low pressure port of the manifold. The high pressure port is in fluid communication with the high pressure channel and the low pressure port is in fluid communication with the low pressure channel. The method also includes a step of threadably attaching a sensor to a sensor port of the manifold. The sensor port is in fluid communication with one of the high pressure channel and the low pressure channel.

### BRIEF DESCRIPTION OF THE DRAWINGS

FIG. 1 is a side diagrammatic view of a machine having an operator control station according to the present disclosure;

FIG. 2 is a block diagram of an air conditioning system for cooling the operator control station of FIG. 1;

FIG. 3 is a perspective view of the compressor manifold attached to a compressor of the air conditioning system of FIG. 2;

FIG. 4 is a first isometric view of the compressor manifold of FIG. 3 having portions cut away to expose internal channels;

FIG. 5 is a second isometric view of the compressor manifold of FIG. 3 having portions cut away to expose internal channels;

FIG. 6 is an isometric view of an alternative configuration of the compressor manifold of FIG. 3; and

FIG. 7 is a perspective view of prior art compressor fittings for use with the air conditioning system of FIG. 2.

### DETAILED DESCRIPTION

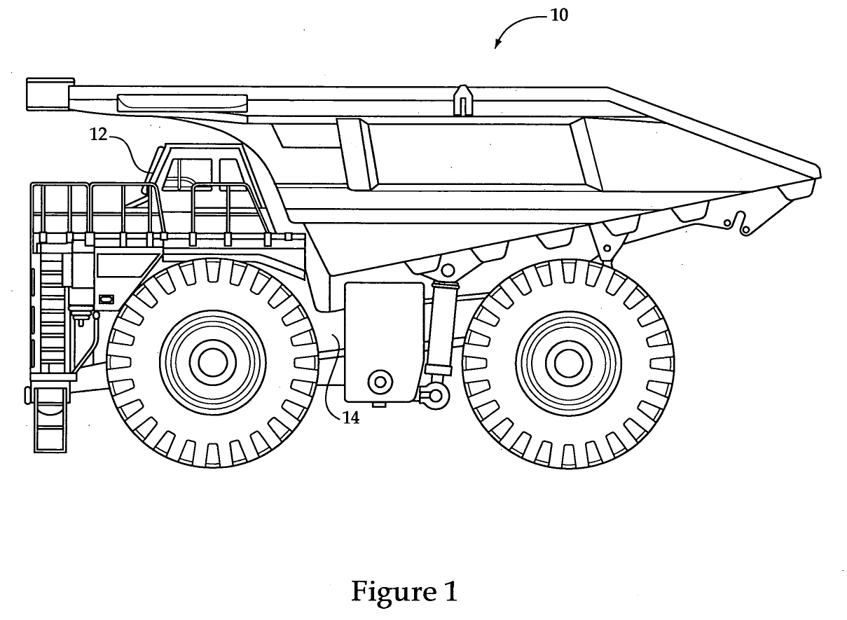

An exemplary embodiment of a machine 10 is shown generally in FIG. 1. The machine 10 may be a mining truck, as shown, or any other machine utilizing a system for cooling an operator control station 12 of the machine 10. Exemplary machines include, but are not limited to, wheel loaders, excavators, track-type tractors, motor graders, and other machines having an operator control station 12. The operator control station 12 is supported by a frame 14 and may include various devices and controllers, including, but not limited to, a seat assembly, a steering assembly, operation pedals, a console equipped with one or more control levers, a monitoring device, and various other machine operation controllers. In addition, the operator control station 12 is equipped with a cooling system, such as an air conditioning system.

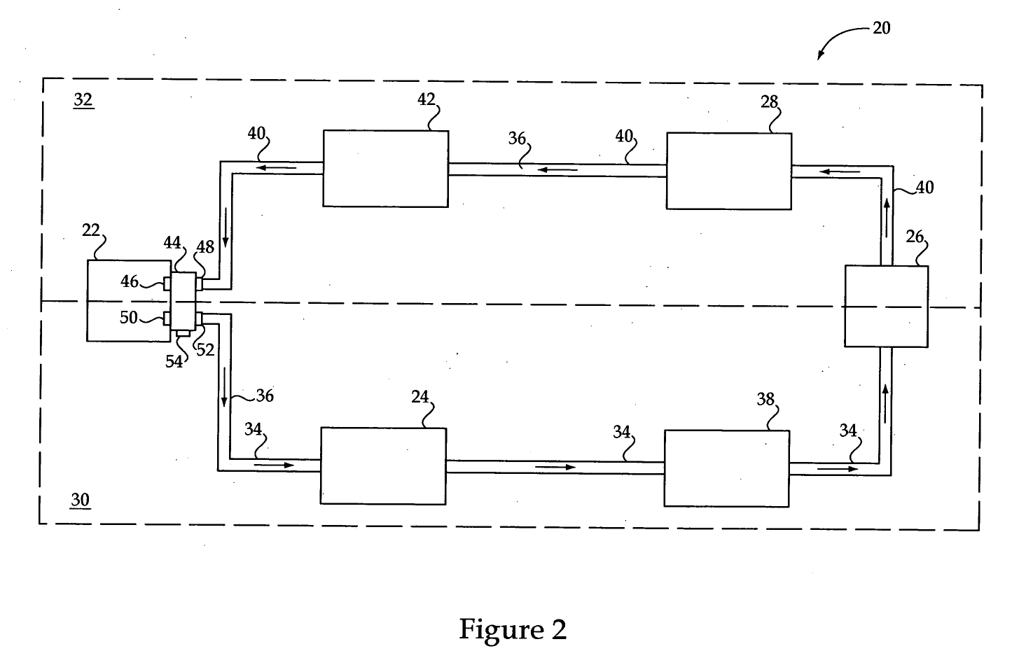

A simplified block diagram of the air conditioning system can be seen generally at 20 in FIG. 2. Machine air conditioning systems, such as air conditioning system 20, are well known and typically include a compressor 22 having a chamber for compressing a coolant. The compressor 22 may be powered by an engine (not shown) of the machine 10, or any alternative power source, and is responsible for compressing a low pressure coolant, such as a refrigerant. The refrigerant may include R12, R134a, or any other liquid capable of vaporizing at a low temperature. The compressed refrigerant, in the form of a high pressure gas, is transported from the compressor 22 to a condenser 24.

The condenser 24 may be positioned near a radiator of the machine 10, or may be positioned at any other location where ambient air is drawn, by a fan or ventilator, through the condenser 24. The condenser 24, by way of the ambient air, removes the heat from the high pressure refrigerant traveling through the condenser 24. As the compressed refrigerant is cooled, it becomes a high pressure liquid. From the condenser 24, the high pressure liquid is transported to a pressure regulating device 26. The pressure regulating device 26 may include, for example, an expansion device, such as a thermal expansion device, an orifice tube, or any other device for controlling the pressure and flow of the cooled liquid.

From the pressure regulating device 26, the cooled and regulated liquid proceeds to an evaporator 28. During the evaporation process, heat is extracted from air passing across the evaporator 28. The cooled air is blown into the operator control station 12 of the machine 10. It may be desirable, therefore, to arrange the evaporator 28 within the operator control station 12 or position the evaporator 28 in communication with the operator control station 12 via ducts or other devices. The compressor 22 then draws in the refrigerant gas from an outlet of the evaporator 28 to repeat the process.

It should be appreciated that the air conditioning system 20 is split into two sides, i.e., a high pressure side 30 and a low pressure side 32. Specifically, the high pressure side 30 includes a high pressure conduit 34 for transporting a refrigerant 36 from the compressor 22 to the condenser 24 and then on to the pressure regulating device 26. A receiver-dryer 38 may be disposed along the high pressure conduit 34 between the condenser 24 and the pressure regulating device 26 for separating gas refrigerant from liquid refrigerant to ensure the pressure regulating device 26 receives only liquid refrigerant. Additionally, the receiver-dryer 38 may remove moisture and filter dirt from the liquid refrigerant.

The low pressure side 32 includes a low pressure conduit 40 for transporting the refrigerant 36 from the pressure regulating device 26 to the evaporator 28 and then on to the compressor 22. An accumulator 42 may also be disposed along the low pressure conduit 40 between the evaporator 28 and the compressor 22. The accumulator 42 stores any excess liquid refrigerant to prevent any liquid from entering the compressor 22. In addition, the accumulator 42 may remove debris and moisture from the refrigerant 36.

A manifold 44 fluidly connects the low pressure conduit 40 to an inlet 46 of the compressor 22. Specifically, the refrigerant 36 travels from a low pressure port 48 through the compressor manifold 44 and into the compressor 22 via compressor inlet 46. The compressor manifold 44 also fluidly connects an outlet 50 of the compressor 22 to the high pressure conduit 34. The refrigerant 36 is transported from the compressor outlet 50 through the compressor manifold 44 and through a high pressure port 52. The compressor manifold 44 may also include one or more additional ports, such as a port 58. Although port 58 is shown connected to the high pressure side of the compressor manifold 44, it should be appreciated that one or more additional ports could be connected to the low pressure side of the compressor manifold 44.

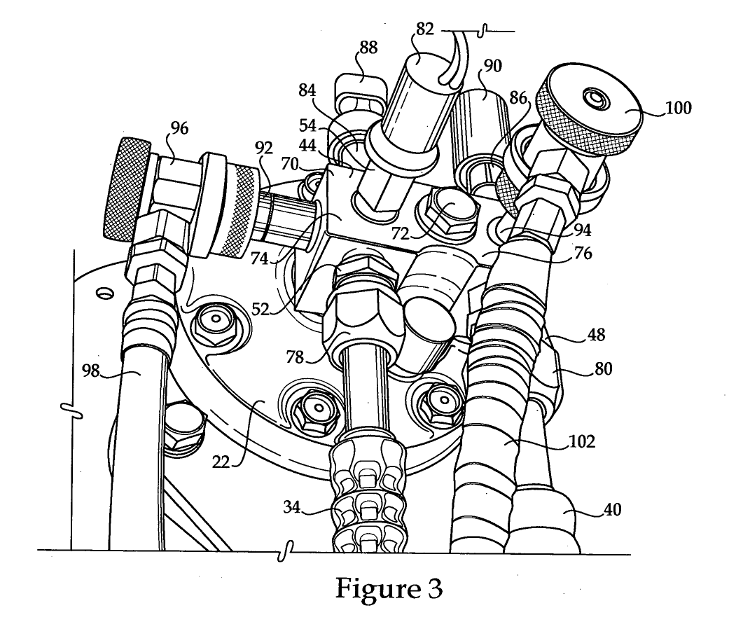

The compressor manifold 44 is shown in greater detail in FIG. 3. The compressor manifold 44 includes a housing 70, such as a box-shaped housing, attached to the compressor 22 via a bolt 72 or other fastening device. Specifically, a high pressure side 74 of the compressor manifold 44 is positioned over the compressor outlet 50 and a low pressure side 76 is positioned over the compressor inlet 48. A seal is created when the compressor manifold 44 compresses o-rings positioned in grooves adjacent each of the compressor inlet 46 and the compressor outlet 50. Although a specific sealing method is described, it should be appreciated that any known sealing arrangement be used.

The compressor manifold 44 may include numerous ports comprising various fittings for attaching conduits, such as hoses, sensors, and servicing lines. Specifically, the high pressure port 52 may include an annular fitting having external threads thereon for attaching a hose coupling 78. Hose coupling 78 is attached to the high pressure conduit 34 and, therefore, hose coupling 78 may be secured to an exterior portion of the annular fitting of high pressure port 52 to connect the compressor 22 to the high pressure side 30 of the air conditioning system 20. Similarly, the low pressure port 48 may include an annular fitting with external threads thereon for attaching a hose coupling 80. Hose coupling 80 is threadably attached to the low pressure conduit 40 and provides a means for connecting the low pressure side 32 of the air conditioning system 20 to the compressor 22.

The additional port 54 of the high pressure side 74 of the compressor manifold 44 may also include an annular fitting having external threads thereon for threadably attaching a sensor 80. Additional ports 84 and 86 may attach to the high pressure side 74 and low pressure side 76, respectively, and may include similar fittings for attaching additional sensors 88 and 90. Exemplary sensors may include, but are not limited to, pressure sensors, temperature sensors, and fan speed sensors. It should be appreciated that specific sensor requirements may dictate the dimensions of each of the ports, and fittings, 54, 84, and 86.

Additional ports 92 and 94 may open through the high pressure side 74 and low pressure side 76, respectively, and may be provided for servicing the air conditioning system 20. Specifically, port 92 may include an annular fitting having at least one external groove thereon for attaching a quick disconnect coupling 96, as is well known in the art. Quick disconnect coupling 96 is attached to high pressure service line 98 and provides a means for connecting the service line 98 to the compressor outlet 50 via the compressor manifold 44. Similarly, port 94 may include an annular fitting having at least one external groove thereon for attaching a quick disconnect coupling 100. Quick disconnect coupling 100 is attached to low pressure service line 102 and provides a means for connecting the service line 102 to the compressor inlet 46 via compressor manifold 44. Services lines 98 and 102 may be connected to gauges for determining temperature and/or pressure within the air conditioning system 20 or, alternatively, to a refrigerant supply in order to recharge the system 20.

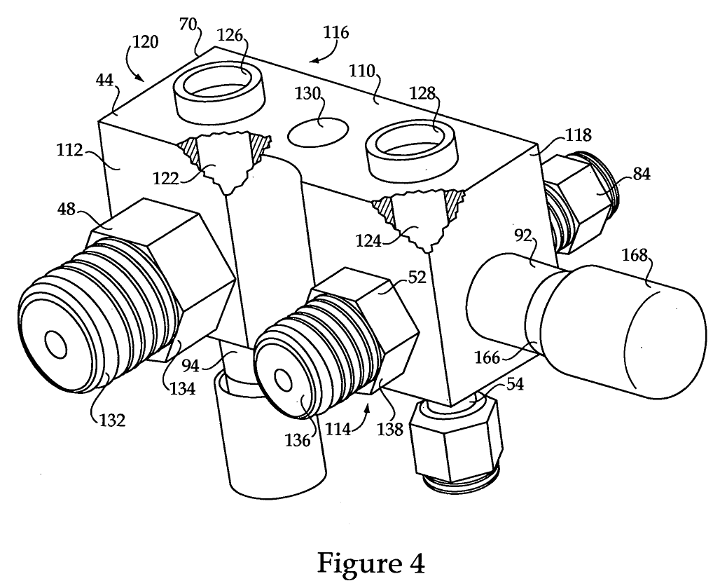

The structure of the compressor manifold 44 can be seen in even greater detail in FIG. 4. Specifically, the housing 70 includes a first face 110, a second face 112, a third face 114, a fourth face 116, a fifth face 118, and a sixth face 120 defining a low pressure channel 122 and a high pressure channel 124. The first face 112 includes a first annular flange 126 for engaging the compressor inlet 46 and a second annular flange 128, parallel to and spaced apart from the first annular flange 126, for engaging the compressor outlet 50. Specifically, the first and second annular flanges 126 and 128 may be received within the compressor inlet 46 and the compressor outlet 50, respectively. A fastener bore 130 extends through the first face 110 of the housing 70 between the low pressure channel 122 and the high pressure channel 124 and is adapted to receive the threaded fastener 72.

The second face 112 of the housing 70 is perpendicular to the first face 110 and includes the low pressure port 48 in fluid communication with the low pressure channel 122 and the high pressure port 52 in fluid communication with the high pressure channel 124. Low pressure port 48, including an annular fitting, may include external threads 132 for attaching a hose coupling, such as, hose coupling 80, and may also include a hexagonal surface 134 for engagement by a tool, such as, for example, a wrench. Similarly, the high pressure port 52, including an annular fitting, may include external threads 136 and a hexagonal surface 138 to assist in securing hose coupling 78 to the port 52.

The third face 114 of the housing 70 is parallel to the first face 110 and includes the sensor port 54 in fluid communication with the high pressure channel 124. The sensor port 54, including an annular fitting, may include external threads 152 thereon for attaching a sensor, such as sensor 82. The sensor port 54 may also include a hexagonal surface 152 for engagement by a tool. As should be appreciated by those skilled in the art, the sensor port 54 may include a valve therein, such as a Schrader valve, to be actuated by a sensor during attachment. The third face 114 also includes the low pressure service port 94 in fluid communication with the low pressure channel 122. The low pressure service port 94 includes an annular fitting having a Schrader valve disposed therein and at least one external groove 154 for attaching a coupling, such as quick disconnect coupling 100. As shown, low pressure service port 94 may be provided with a dust cap 156 for preventing dust and moisture from entering the valve and/or port 94.

The fourth face 116 is parallel to the second face 112 and includes sensor port 84 in fluid communication with the high pressure channel 124 and sensor port 86 in fluid communication with the low pressure channel 122. The sensor port 84, including an annular fitting, may include external threads 158 for attaching sensor 88 and a hexagonal surface 160 for engagement by a tool. Similarly, sensor port 86 includes external threads 162 and a hexagonal surface 164. Sensor ports 84 and 86 may also include valves, such as well known Schrader valves, disposed therein.

The fifth face 118, shown best in FIG. 4, includes the high pressure service port 92 in fluid communication with the high pressure channel 124. The high pressure service port 92 includes an annular fitting having a Schrader valve disposed therein and includes at least one external groove 166 for attaching quick disconnect coupling 96. As shown, high pressure service port 92 may be provided with a dust cap 168 for preventing dust and moisture from entering the valve and/or port 92. Although the sixth face 120 does not include any ports opening therethough, it should be appreciated that the present disclosure contemplates various configurations of the compressor manifold 44 in which numerous ports may open through any of the six faces 110, 112, 114, 116, 118, and 120.

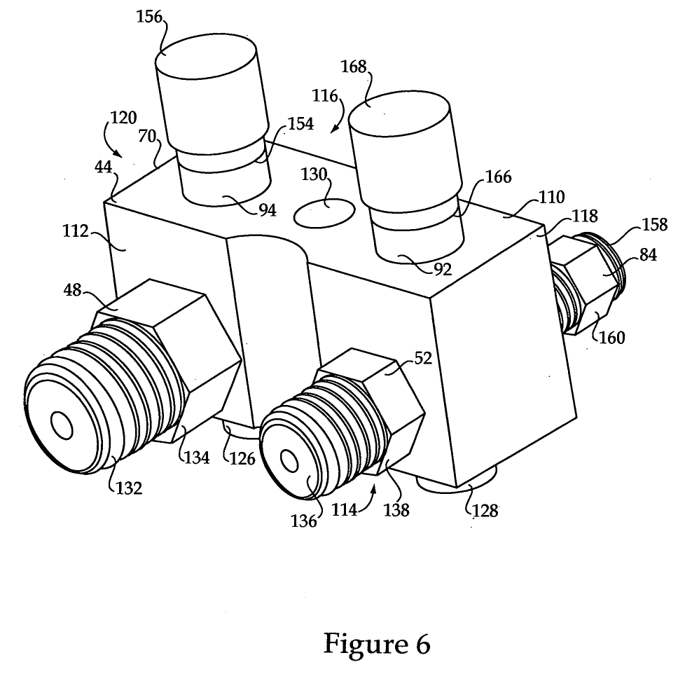

As an example, FIG. 6 shows an alternative embodiment of the compressor manifold 44. Specifically, the first face 110 of the housing 70 includes high pressure service port 92 and the low pressure service port 94. The annular flanges 126 and 128, previously opening through the first face 110, open, in the current embodiment, through the third face 114. The high pressure port 52 and low pressure port 48 still open through the second face 112. Only one additional port, sensor port 84, is provided in fluid communication with the high pressure channel 124 and opens through the fourth face 116.

It should be appreciated that the compressor manifold 44 may include any number and configuration of ports based on the requirements of a specific application. For example, the housing 70 may be machined to a specific structure and that defines the low pressure passage 122 and the high pressure passage 124. Bores may be created, such as by drilling, through various faces, such as faces 110, 112, 114, 116, 118, and 120, of the housing 70 and into fluid communication with either of the low pressure passage 122 and high pressure passage 124. Ports or fittings of varying sizes and configurations may be attached to or secured within the bores, such as by brazing or welding. The various ports and fittings may be adapted to accommodate their intended uses. Although specific fittings, such as threaded and/or slip-on type fittings and couplings, have been identified, it should be appreciated that any fittings for connecting conduits, hoses, sensors, service lines, etc. are contemplated.

### INDUSTRIAL APPLICABILITY

The current disclosure may relate to air conditioning systems generally or, according to a specific example, may relate to air conditioning systems for cooling an operator control station of a machine, such as a mining truck. Specifically, a compressor manifold is described that may be included within an air conditioning system provided by an original equipment manufacturer. Alternatively, however, the compressor manifold may be provided as a retrofit for such air conditioning systems.

Referring to FIGS. 1 and 2, an air conditioning system 20 for cooling an operator control station 12 of a machine 10 typically includes a compressor 22 having a chamber for compressing a refrigerant. The compressed refrigerant, in the form of a high pressure gas, is transported from the compressor 22 to a condenser 24 positioned near a radiator of the machine 10. The condenser 24, by way of the ambient air, removes the heat from the high pressure refrigerant traveling through the condenser 24. As the compressed refrigerant is cooled, it becomes a high pressure liquid. From the condenser 24, the high pressure liquid is transported to a pressure regulating device 26. The pressure regulating device 26 may include, for example, an expansion device, such as a thermal expansion device, an orifice tube, or any other device for controlling the pressure and flow of the cooled liquid.

From the pressure regulating device 26, the cooled and regulated liquid proceeds to an evaporator 28. During the evaporation process, heat is extracted from air passing across the evaporator 28. The cooled air is blown into the operator control station 12 of the machine 10. It may be desirable, therefore, to arrange the evaporator 28 within the operator control station 12 or position the evaporator 28 in fluid communication with the operator control station 12. The compressor 22 then draws in the refrigerant gas from an outlet of the evaporator 28 and repeats the process.

The compressor 22 of the air conditioning system 20 is basically a pump having an intake 48 for drawing in a low pressure refrigerant gas and a discharge 52 for releasing the high pressure, or compressed, refrigerant gas. The intake 48 typically receives the refrigerant gas through a hose or conduit coupled to the intake via an appropriate fitting. Similarly, the compressed refrigerant gas is transported from the discharge 52 and through a hose coupled to the discharge via an additional fitting.

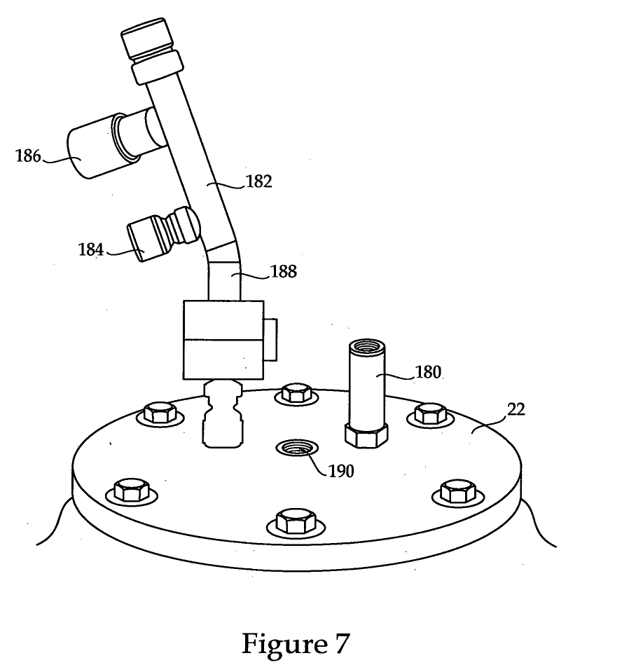

In some applications, as shown in FIG. 7, one or both of the compressor fittings, such as a low pressure fitting 180 and a high pressure fitting 182, may have a substantial length, and may include one or more bends, due to spatial constraints and/or access limitations. Specifically, for example, high pressure fitting 182 may include one or more additional ports or valves, such as ports 184 and 186, for attaching sensors and/or service lines and, therefore may require a specific configuration to accommodate access to each of the additional ports and valves. However, since many machines operate in environments subject to extreme vibrations, the length of these fittings may contribute to premature failures at the bends and/or connections, such as, for example, a bend 188 of high pressure fitting 182. In addition to possible vibrations, the high pressure fitting 182, attached to the discharge side 50 of the compressor 22 will experience cyclic loads when the compressor surges and may be subject to increased cyclic stresses at these joints.

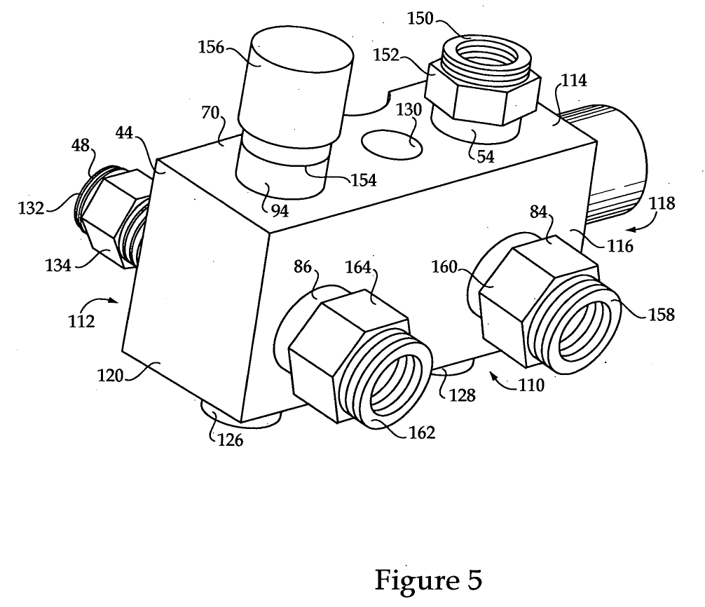

The compressor manifold 44 of FIGS. 3-6 may replace the fittings 180 and 182 provide a versatile structure that is more able to resist damage from the vibrations and cyclic stresses, which may have contributed to failures of fittings 180 and 182. The compressor manifold 44 may serve as a retrofit for applications currently using separate fittings, such as fittings 180 and 182. For example, the low pressure, or inlet, fitting 180 that is coupled directly with the compressor inlet 46 may be removed. Similarly, the high pressure, or outlet, fitting 182, coupled directly to compressor outlet 50, may be removed. The box-shaped compressor manifold 44 may thereafter be positioned over the compressor inlet 46 and compressor outlet 50. The low pressure channel 122 is positioned in fluid communication with the compressor inlet 46 and the high pressure channel 124 is positioned in fluid communication with the compressor outlet 50. The compressor manifold 44 is then secured to the compressor 22 by extending the threaded fastener 72 through fastener bore 130 and into a threaded receiving bore of the compressor 22, such as receiving bore 190 of FIG. 7.

High pressure conduit 34 is then coupled to the high pressure port 52 using hose coupling 78, while low pressure conduit 40 is coupled to the low pressure port 48 via hose coupling 80. It should be appreciated that the high pressure port 52 is in fluid communication with the high pressure channel 124 and the low pressure port 48 is in fluid communication with the low pressure channel 122. In addition, a sensor, such as sensor 82, may be threadably attached to additional port 54. According to the current embodiment, additional port 54 is in fluid communication with high pressure channel 124. However, it should be appreciated that numerous additional ports may open through any of the faces 110, 112, 114, 116, 118, and 120 of the compressor manifold 44 and may be in fluid communication with either of the high pressure channel 124 and the low pressure channel 122.

Additionally, low pressure service line 102 may be attached to low pressure service port 94 using quick disconnect coupling 100, and high pressure service line 98 may be attached to high pressure service port 92 via quick disconnect coupling 96. It should be appreciated that attaching any of the sensor 82 and couplings 96 and 100 may include opening a Schrader valve disposed within any of the ports 54, 92, and 94, respectively.

Although specific embodiments are given, it should be appreciated that the present disclosure contemplates various configurations of the compressor manifold 44 in which numerous ports may open through any of the six faces 110, 112, 114, 116, 118, and 120. The configuration chosen may depend on requirements of the specific application, such as, for example, spatial constraints and access limitations.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A machine having an air conditioning system, comprising:
a compressor having an inlet and an outlet;
a manifold having a housing attached to the compressor, wherein the housing defines a low pressure channel for directing a low pressure refrigerant from a low pressure port of the manifold to the compressor inlet and a high pressure channel for directing a compressed refrigerant from the compressor outlet to a high pressure port of the manifold; and
wherein the manifold includes at least one additional port in fluid communication with one of the high pressure channel and the low pressure channel.

2. The machine of claim 1, wherein a first face of the manifold housing includes a first annular flange for engaging the compressor inlet and a second annular flange parallel to and spaced apart from the first annular flange for engaging the compressor outlet.

3. The machine of claim 2, wherein the manifold housing includes a second face, a third face, a fourth face, a fifth face, and a sixth face; and
wherein each of the high pressure port and the low pressure port opens through one of the second through sixth faces and includes an annular fitting having external threads thereon for attaching a hose coupling.

4. The machine of claim 3, wherein a high pressure conduit is connected to the high pressure port using a hose coupling; and
wherein a low pressure service conduit is connected to the low pressure port using a hose coupling.

5. The machine of claim 3, wherein the at least one additional port is a first sensor port; and
wherein the first sensor port opens through one of the second through sixth faces and includes an annular fitting having external threads thereon for attaching a sensor.

6. The machine of claim 5, further including a second sensor port and a third sensor port, wherein each of the second sensor port and the third sensor port is in fluid communication with one of the high pressure channel and the low pressure channel; and
wherein each of the second sensor port and the third sensor port opens through one of the second through sixth faces and includes an annular fitting having external threads thereon for attaching a sensor.

7. The machine of claim 6, wherein the annular fitting of at least one of the first sensor port, second sensor port, and third sensor port includes a Schrader valve disposed therein.

8. The machine of claim 5, further including a high pressure service port in fluid communication with the high pressure channel and a low pressure service port in fluid communication with the low pressure channel; and
wherein each of the high pressure service port and the low pressure service port opens through one of the second through sixth faces and includes an annular fitting having at least one external groove thereon for attaching a quick disconnect coupling.

9. The machine of claim 8, wherein the annular fitting of each of the high pressure service port and low pressure service port includes a Schrader valve disposed therein.

10. The machine of claim 9, wherein a high pressure service line is connected to the high pressure service port using a quick disconnect coupling; and
wherein a low pressure service line is connected to the low pressure service port using a quick disconnect coupling.

11. A compressor manifold for an air conditioning system of a machine, comprising:
a housing having a first face, a second face, a third face, a fourth face, a fifth face, and a sixth face defining a low pressure channel and a high pressure channel, wherein the first face includes a first annular flange for engaging the compressor inlet and a second annular flange parallel to and spaced apart from the first annular flange for engaging the compressor outlet;
a low pressure port opening through one of the second through sixth faces and in fluid communication with the low pressure channel;
a high pressure port opening through one of the second through sixth faces and in fluid communication with the high pressure channel;
a fastener bore extending through the housing between the low pressure channel and the high pressure channel for receiving a fastener therethrough; and
at least one additional port opening through one of the second through sixth faces and in fluid communication with one of the high pressure channel and the low pressure channel.

12. The compressor manifold of claim 11, wherein each of the high pressure port and the low pressure port opens through the second face and includes an annular fitting having external threads thereon for attaching a hose coupling; and
wherein the second face is perpendicular to the first face.

13. The compressor manifold of claim 12, wherein the at least one additional port is a first sensor port in fluid communication with the high pressure channel;
wherein the first sensor port opens through the third face and includes an annular fitting having a Schrader valve disposed therein and external threads thereon for attaching a sensor; and
wherein the third face is parallel to the first face.

14. The compressor manifold of claim 13, further including a second sensor port and a third sensor port, wherein the second sensor port is in fluid communication with the high pressure channel and the third sensor port is in fluid communication with the low pressure channel;
wherein each of the second sensor port and the third sensor port opens through the fourth face and includes an annular fitting having external threads thereon for attaching a sensor; and
wherein the fourth face is parallel to the second face.

15. The compressor manifold of claim 14, further including a low pressure service port in fluid communication with the low pressure channel and a high pressure service port in fluid communication with the high pressure channel; and
wherein the low pressure service port opens through the third face and the high pressure service port opens through the fifth face; and
wherein each of the low pressure service port and high pressure service port includes an annular fitting having a Schrader valve disposed therein and at least one external groove for attaching a quick disconnect coupling.

16. The compressor manifold of claim 15, wherein each of the low pressure service port and the high pressure service port includes a dust cap threadably attached thereto.

17. A method of assembling an air conditioning system of a machine, comprising:
positioning a manifold over a compressor inlet and a compressor outlet, wherein a low pressure channel of the manifold is in fluid communication with the compressor inlet and a high pressure channel of the manifold is in fluid communication with the compressor outlet;
securing the manifold to the compressor with a threaded fastener extending through a fastener bore within the manifold and into a threaded receiving bore within the compressor;
coupling a high pressure conduit to a high pressure port of the manifold, wherein the high pressure port is in fluid communication with the high pressure channel;
coupling a low pressure conduit to a low pressure port of the manifold, wherein the low pressure port is in fluid communication with the low pressure channel; and
threadably attaching a sensor to a sensor port of the manifold, wherein the sensor port is in fluid communication with one of the high pressure channel and the low pressure channel.

18. The method of claim 17, further including:
removing an inlet fitting coupled directly with the compressor inlet; and
removing an outlet fitting coupled directly with the compressor outlet.

19. The method of claim 17, wherein the threadably attaching step includes opening a Schrader valve positioned within the sensor port.

20. The method of claim 17, further including:
attaching a low pressure service line to a low pressure service port of the manifold using a quick disconnect coupling; and
attaching a high pressure service line to a high pressure service port of the manifold using a quick disconnect coupling.
